(19) United States
(12) Patent Application Publication
(10) Pub. No.: US 2010/0089191 A1
(43) Pub. Date: Apr. 15, 2010

(54) ACTUATOR WITH INTEGRATED LOCKING DEVICE

(75) Inventor: Thierry Marin Martinod, Nesles La Vallee (FR)

Correspondence Address: CANTOR COLBURN, LLP, 20 Church Street, 22nd Floor, Hartford, CT, 06103, US

(73) Assignee: AIRCELLE, GONFREVILLE L'ORCHER (FR)

(21) Appl. No.: 12/527,584

(22) PCT Filed: Oct. 26, 2007
(86) PCT No.: PCT/FR2007/001769

§ 371 Date: Aug. 18, 2009

(30) Foreign Application Priority Data
Feb. 22, 2007 (FR) 07 01255

(51) Int. Cl. F16H 25/20; F16H 25/24; B64C 13/24

(52) U.S. Cl. 74/89.39

(57) ABSTRACT

The invention relates to a jack (1) that comprises, on the one hand, a rod (2) that can be driven in translation by a driving system (5, 6), and, on the other hand, a system for blocking the expansion of the rod that comprises at least one bolt (9) mounted so as to move between an engagement position, in which it defines an abutment means for the rod in the expansion direction thereof, and a release position, in which it is spaced away from the rod and allows the expansion thereof, wherein the bolt is associated with a barrel (14) having a first stable position in which it maintains the bolt (9) in the engagement position and a second stable position in which it maintains the bolt (9) in its release position, said barrel system (14) being designed so that it can be alternatively switched from the first stable position to the second stable position under the action of the rod (2) driven by a slight backward movement before expansion and at the end of the return stroke.

### TECHNICAL FIELD OF THE INVENTION

The present invention relates to an actuator comprising an integrated mechanical locking system and is more particularly directed towards an actuator for fitting to an actuating system for a thrust reverser for a turbojet.

### BRIEF DESCRIPTION OF RELATED ART

The job of a thrust reverser when an airplane is landing is to improve the braking ability of the airplane by redirecting forwards at least part of the thrust generated by the turbojet. During this phase the reverser blocks the gas ejector nozzle and directs the ejected gases from the engine towards the front of the nacelle, thereby generating an opposing thrust which assists the braking through the wheels of the airplane.

The means employed to bring about this redirection of the gases varies depending on the type of reverser. However, in all cases the structure of a reverser comprises surfaces which are movable between, on the one hand, a deployed position in which they open a passage in the nacelle for the deflected gases, and, on the other hand, a withdrawn position in which they close this passage. These movable surfaces can also perform a deflecting function or simply activate other deflecting means.

In cascade thrust reversers, for example, the movable surfaces slide along rails in such a way that as they move aft during the opening phase, they uncover cascades, which are deflecting vanes located within the thickness of the nacelle. A linkage system connects this movable surface to blocker doors which deploy into the ejector channel and block off the direct ejection path. In clamshell thrust reversers, on the other hand, each movable surface pivots in such a way as to block the gases and deflect them and is therefore active in this redirection.

Generally speaking, these movable surfaces are actuated by hydraulic, pneumatic or electrical actuators.

For obvious safety reasons, these actuators must be fitted with locks to keep them in the retracted position and prevent any accidental deployment of a movable surface of the thrust reverser.

Two types of locks are generally distinguished: primary locks which are mounted as a pair, and tertiary locks.

The two primary locks hold each movable surface in the nominal retracted position and absorb any loads that would tend to translate said movable surface. These locks are redundant to allow for possible failure of one of the primary locks, each lock being engineered to be able to absorb all of the loads that could tend to cause translation of the movable surface.

The tertiary lock does not absorb any loads during nominal operation. Its function is that of an emergency locking system that is required to absorb any loads tending to cause translation of the movable surface only if the two primary locks fail.

These locks are usually activated by way of a control signal which is sent as part of the thrust reverser opening procedure. They therefore require their own electrical power supply.

These locks are important flight safety components and there is still a need for a lock that is simultaneously reliable, strong, lightweight and simple.

### BRIEF SUMMARY OF THE INVENTION

The invention provides an improved actuator incorporating a locking system that can act as a tertiary lock and for this purpose includes an actuator comprising on the one hand a rod able to be translated by a drive system, and on the other hand a rod deployment locking system (termed the tertiary lock) comprising at least one latch mounted movably between an engaged position in which it constitutes a stop means for the rod in the direction of its deployment, and a disengaged position in which it is withdrawn from the rod and allows it to deploy, said actuator being characterized in that the latch is connected to a barrel system possessing a first stable position in which it allows the latch to be held in its engaged position and a second stable position in which it allows the latch to be held in its disengaged position, said barrel system being arranged in such a way as to be able to pivot alternately from its first stable position to its second stable position when the rod is moved slightly backwards before being deployed and at the end of the retraction stroke.

The connection of the latch to a barrel system thus results in a completely mechanical locking system that has no need of electrical control means, being automatically locked and unlocked as the rod follows the appropriate sequence, that is to say comprises a slight backward movement before deployment or a longer stroke during its retraction. This reversal of direction before deployment is an important aspect of the improvement to the security of the locking and unlocking of the actuator.

The latch is advantageously mounted in opposition to an elastic return means. Also advantageously, the elastic return means tends to return the latch to its disengaged position.

The barrel system preferably constitutes a movable stop means for the latch.

The latch is advantageously made in the form of a pivoting hook possessing a first end able to form a stop means for the deploying rod and a second end able to abut against the barrel.

The second end of the latch is preferably beveled.

The barrel also preferably has at least one beveled surface complementary to the second end of the latch and against which the latch abuts.

In a preferred embodiment, the rod is actuated by a screw and nut drive system, the rod being prevented from turning.

The nut is advantageously located on the rod.

Also advantageously, the nut is integrated with the rod and is in the form of an internal tapped hole.

The actuator is preferably an electric actuator.

### BRIEF DESCRIPTION OF THE DRAWINGS

The application of the invention will be understood more fully from a perusal of the detailed description set out below with reference to the appended drawing, in which:

FIG. 1 is a schematic cross section through an actuator as claimed in the invention comprising a system for locking it in the engaged position before deployment;

FIG. 2 is a schematic view of the actuator seen in FIG. 1 in the unlocked position before deployment;

FIG. 3 is a schematic view of the actuator seen in FIG. 1 in the course of deployment following unlocking; and

FIG. 4 is a schematic view of the actuator seen in FIG. 1 in the locked position after retraction.

### DETAILED DESCRIPTION OF THE INVENTION

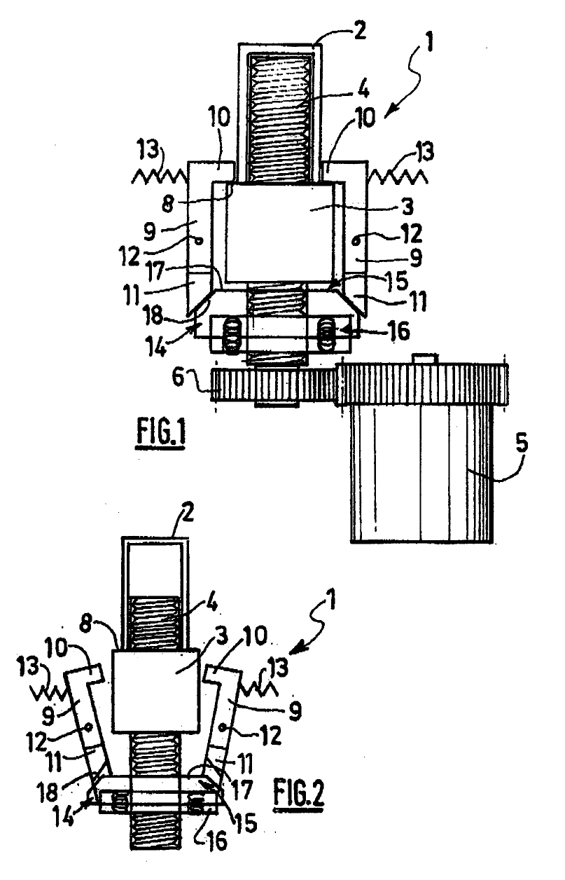

In FIGS. 1-4, an actuator 1 according to the invention comprises a rod 2 which is prevented from turning and comprises a nut 3 located at the start of the rod 2 to form a base presenting a circumferential shoulder 8. The actuator is such as to operate in conjunction with a threaded screw 4 housed inside the rod 2.

Traditionally, the threaded screw 4 is turned by an electric motor 5 connected to a speed reducer 6. The rod 2 is unable to turn, so the movement of the threaded screw 4 is turned into a translational movement by which the rod 2 is deployed or retracted depending on the direction of rotation of the threaded screw 2.

The actuator 1 also includes an integrated mechanical locking system.

This locking system comprises a pair of lateral hooks 9 which have a first end forming a return 10 of the hook directed towards the rod 2 and a second end 11 that has a beveled surface which is also directed towards the rod 2.

Each hook 9 pivots about an axis 12, allowing it to pivot between an engaged position (FIGS. 1 and 4) in which the return 10 is brought to the rod 2 and forms a stop for the shoulder 8 in the direction of rod deployment, and a disengaged position in which the return 10 is drawn back from the rod 2 and allows it to deploy.

Each hook 9 is also mounted in opposition to an elastic return means 13 which tends to return it to its disengaged position, said elastic return means being attached approximately level with the return 10 of each hook 9.

Lastly, each hook 9 is connected to a barrel system 14 arranged in line with the rod 2 just behind the nut 3 acting as a base for said rod 2. This barrel system 14 has a smooth central recess for the passage of the threaded screw 4 and its connection to the speed reducer 6.

The barrel 14 comprises a bearing head 15 mounted on a spring-loaded rocker 16 which allows the bearing head 15 to move between a withdrawn position and an advanced position in the direction of the rod 2.

The bearing head 15 has a contact surface 17 opposite the base of the rod 2 and a beveled peripheral surface 18 so oriented as to form a complementary surface to the beveled surface on the end 11 of each hook 9.

The stages in the operation of the integrated locking system will now be described.

Initially, as shown in FIG. 1, the rod 2 of the actuator 1 is retracted. Each hook 9 is in the engaged position against the shoulder 8 of the base of the rod 2 and the bearing head 15 of the barrel system 14 is in the advanced position so that its beveled peripheral surface 18 is in contact with the beveled surface on the end 11 of each hook 9.

In this configuration, each elastic return means 13 of each hook 9 tends to pivot the latter into its disengaged position. Each hook 9 is prevented from pivoting by the beveled peripheral surface 18 of the barrel system 14, which acts as a stop for the end 11 of each hook 9 and thus prevents it from pivoting.

A deployment of the rod 2 commences with a slight backward movement of the rod. As it does so, the base of the rod 2 presses against the bearing head 15 of the barrel system 14 and pivots the latter into its second stable position, in which the bearing head 15 is withdrawn from its initial position.

In this configuration the beveled peripheral surface 18 is moved back from the end 11 of each hook 9 and can no longer act as a stop against it.

Due to the action of its corresponding elastic return means 13, each hook 9 therefore pivots about its axis 12 towards its disengaged position, with the return 10 of each hook 9 moving away from the rod 2 and so releasing the shoulder 8.

As a result, the rod is now free to deploy and the movement of the electric motor 5 is reversed in order to proceed with deploying said rod 2 (FIG. 2).

The actuator 1 will be locked in the same way.

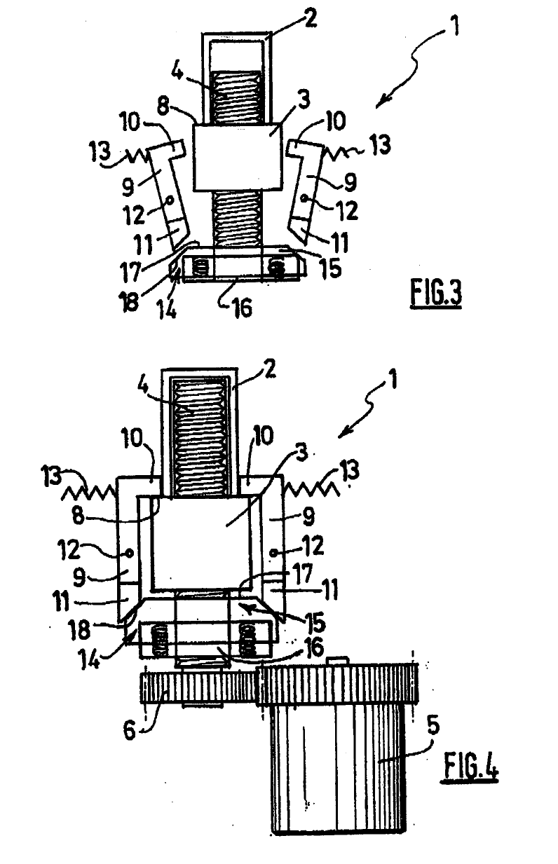

Beginning with the previous position, as shown in FIG. 3, the electric motor 5 rotates in a direction corresponding to retraction of the rod 2.

At the end of the stroke, the backward movement continues for a short distance so that the base of the rod 2 presses against the bearing head 15 of the barrel system 14, pivoting it back to its first stable position in which the bearing head 15 slightly forward compared to its previous position. The rod then returns to its normal end-of-stroke position.

As this is done, the beveled peripheral surface 18 abuts against the end 11 of each hook 9 and forces it to pivot about the corresponding axis 12.

The return 10 of each hook 9 then moves back to its engaged position, in which it acts as a stop means against the shoulder 8 to prevent the rod 2 from deploying.

The actuator is thus locked once again.

It should be pointed out that such a locking system is completely mechanical, and requires no signal to open or close it. Locking and unlocking are carried out with the simple addition of a preceding rearward phase in the steps of deployment and retraction of the rod 2.

As claimed in the invention, each hook is automatically pivoted between its engaged position and disengaged position when the rod 2 is moved slightly backwards.

Although the invention has been described in connection with specific illustrative embodiments, it goes without saying that it is in no way limited to these and that it encompasses all technical equivalents of the means described as well as their combinations, where these lie within the scope of the invention.

1. An actuator comprising:
a rod able to be translated by a drive system; and
a rod deployment locking system comprising at least one latch mounted movably between an engaged position in which the latch constitutes a stop means for the rod in a direction of deployment, and a disengaged position in which the latch is withdrawn from the rod and allows the rod to deploy;
wherein the latch is connected to a barrel system possessing a first stable position in which the latch is held in the engaged position and a second stable position in which the latch is held in the disengaged position; and
wherein said barrel system is arranged in such a way as to be able to pivot alternately from the first stable position to the second stable position when the rod is moved slightly backwards before being deployed and at the end of the retraction stroke.

2. The actuator as claimed in claim 1, wherein the latch is mounted in opposition to an elastic return means.

3. The actuator as claimed in claim 2, wherein the elastic return means tends to return the latch to the disengaged position.

4. The actuator as claimed in claim 1, wherein the barrel system constitutes a movable stop means for the latch.

5. The actuator as claimed in claim 1, wherein the latch is made in the form of a pivoting hook possessing a first end able to form a stop means for the deploying rod and a second end able to abut against the barrel when the latter is in its first stable position.

6. The actuator as claimed in claim 5, wherein the second end of the latch is beveled.

7. The actuator as claimed in claim 6, wherein the barrel has at least one beveled surface complementary to the second end of the latch and against which the latch abuts when the barrel is in the first stable position.

8. The actuator as claimed in claim 1, wherein the rod is actuated by a screw and nut drive system, the rod being prevented from turning.

9. The actuator as claimed in claim 8, wherein the nut is located on the rod.

10. The actuator as claimed in claim 9, wherein the nut is integrated with the rod and is in the form of an internal tapped hole.

11. The actuator as claimed in claim 1, wherein the actuator is an electric actuator.
